(19) United States
(12) Patent Application Publication
(10) Pub. No.: US 2020/0095495 A1
(43) Pub. Date: Mar. 26, 2020

(54) CONFORMANCE CONTROL AND SELECTIVE BLOCKING IN POROUS MEDIA THROUGH DROPLET-DROPLET INTERACTIONS IN NANOPARTICLE STABILISED EMULSIONS

(71) Applicant: UTI LIMITED PARTNERSHIP, Calgary (CA)

(72) Inventors: Aseem Pandey, Calgary (CA); Ali Telmadarreie, Calgary (CA); Milana Trifkovic, Calgary (CA); Steven Bryant, Calgary (CA)

(21) Appl. No.: 16/578,006

(22) Filed: Sep. 20, 2019

Related U.S. Application Data
(60) Provisional application No. 62/734,681, filed on Sep. 21, 2018.

(51) Int. Cl. C09K 8/588; C09K 8/26

(52) U.S. Cl. CPC C09K 8/588; C09K 2208/10; C09K 8/26

(57) ABSTRACT

Processes are provided for conformance control in an enhanced oil recovery operation. These processes may for example provide for the use of cellulose nanocrystals (CNCs), for example desulfated CNCs, or chitin nanoparticles, for example having an average maximum dimension of ≤1 μm. These CNCs or chitin nanoparticles may be used to generate a CNC-stabilized oil in water emulsion, which may then be injecting into a zone of a porous subsurface formation. The injected CNC or chitin-stabilized emulsion may be allowed to form strong droplet networks with by resting in situ in the zone of the porous subsurface formation, so as to increase the viscosity of the rested injected CNC or chitin-stabilized emulsion. These emulsions may be used as a selective phase blocking agent or relative permeability modifier, as the strength of the droplet network is governed by the dielectric constant of the surrounding fluid.

### PRIORITY CLAIM

This application claims priority from U.S. Provisional Application No. 62/734,681 filed Sep. 21, 2018. The above application is hereby incorporated by reference as if fully set forth herein.

### FIELD

The invention is in the field of techniques for enhanced oil recovery, in particular for conformance control by a nanoparticle, such as cellulose nanocrystal (CNC) or chitin nanoparticle-stabilized emulsions, including techniques where yield stress of the emulsion is governed by droplet-droplet interactions.

### BACKGROUND

Water flooding is a common secondary oil recovery technique, which may suffer from problems such as rapid channeling of water through higher permeable zones of the reservoir—resulting in poor volumetric sweep efficiency, lower oil production (Mandal and Bera, 2015) and increased water production. In the context of water flooding processes, water production can significantly affect the economics of oil and gas recovery operations. Consequently, alternative enhanced oil recovery (EOR) techniques are needed.

EOR techniques may be categorized as one of three main processes: thermal, chemical and miscible flooding. Chemical EOR methods generally involve injecting polymers, surfactants, alkali or emulsions to increase oil production. Injection of oil in water emulsion has been shown to increase the sweep efficiency of water flooding by efficiently blocking high permeability channels and mobilizing oil from the less permeable zones—resulting in an increase in oil recovery (C. D. McAuliffe, 1973; Abou-Kassem and Ali, 1995; Guillen et al., 2012; Thomas and Farouq Ali, 1989). Similarly, in order to reduce water production, various surfactant stabilized emulsions, polymers and siloxane based microemulsions have been used. Siloxane based microemulsions were reported to have a substantial increase in oil recovery by altering the rock wettability (Kalfoglou, 1981). However, siloxanes have been reported to poison the reforming catalyst in refineries, therefore their concentration in crude oil is restricted to 1 ppm (Demikhova et al., 2016). Polymers have been shown to control the relative movement of water and improve the sweep efficiency but require higher injection volumes and their efficiency can be adversely affected by the salinity, pH, wettability of rock and temperature (Farias et al., 2012). Surfactants are susceptible to thermal degradation and require advanced design to cope with harsh reservoir environments where high temperature and salinity are encountered (Kim et al., 2016).

In the early 1900s it was disclosed that solid particles can be used as an alternative to surfactant stabilized emulsions (Pickering, 1907) and this approach may provide long-term stability to the emulsions by virtue of strong adsorption at the fluid-fluid interface (Binks and Horozov, 2006). Furthermore, nanopartidces are reported to have high chemical and physical stability in harsh reservoir conditions and may be more cost effective and environmental friendly compared to surfactants (Arab et al., 2018).

Cellulose nanocrystals (CNCs) are derived from abundant renewable biomass and exhibit unique functional properties such as high stiffness, high surface area and large aspect ratio (Habibi et al., 2010). Sulfated CNCs, in the presence of salt, and desulfated CNCs have been shown to act as emulsion stabilizers, a function ascribed to the amphiphilic nature of CNCs (Cherhal et al., 2016; Kalashnikova et al., 2012, 2011).

Surfactant stabilized dilute oil in water emulsions (φ_{O}=0.005-0.2) have been used to model emulsion transport through porous media. Three major models that have been developed are based on: (a) bulk viscosity of the emulsions (Abou-Kassem and Ali, 1995) (b) delayed drop models (C. McAuliffe, 1973) (c) filtration models (Soo et al., 1986; Soot and Radke, 1984). Soo and Radke (Soo et al., 1986) reported that an unstable emulsion flowing through porous media effectively blocks the pore throat due to an increase in droplet diameter by coalescence. The deep bed filtration model developed by Soo et al. explains permeability reduction as being caused by two effects: straining and interception. In the case of straining, oil droplet diameter is comparable to the pore constriction, thereby reducing permeability by effectively blocking pore constrictions (Khambharatana et al., 1998). In interception, oil droplets interact with the pore walls due to van der Waals forces, thereby causing reduction in permeability (Demikhova et al., 2016).

### SUMMARY

The present innovations relate, in one aspect, to the flow behavior and stability of oil in water emulsions stabilized by CNCs or chitin nanoparticles in porous media, such as unconsolidated formations, and the application of these emulsions in EOR and conformance control. The methods disclosed herein have the demonstrated potential to make use of a naturally occurring biodegradable nanomaterial for conformance control and for curbing excessive water production in EOR operations, for example where zonal isolation is difficult to achieve.

Accordingly, aspects of the present innovation include processes for conformance control in an enhanced oil recovery operation. These processes may for example provide for the use of desulfated cellulose nanocrystals, or chitin nanoparticles, for example having an average maximum dimension of ≤1 μm. These CNCs or chitin nanoparticles may be used to generate a CNC or chitin-stabilized oil in water emulsion, which may then be injected into a zone of a porous subsurface formation. These emulsions have a demonstrated tendency to form a strong droplet network with time, putatively attributed to van der Waals interactions/Hydrogen bonding between CNCs or chitin nanoparticles adsorbed on the droplet surfaces. The injected CNC or chitin-stabilized emulsion may accordingly be rested in situ in the zone of the porous subsurface formation, so as to increase the viscosity of the rested injected CNC or chitin-stabilized emulsion with time. Another aspect of the disclosed innovations is the blocking efficiency of the emulsion to the oil phase. In particular, a significantly larger pressure gradient is needed to induce water to flow through a rested emulsion than for oil, evidencing the use of this class of emulsions for selective phase blocking, and accordingly as a relative permeability modifier.

Also provided are hydrocarbon reservoirs that include the rested CNC or chitin-stabilized emulsions. These innovations accordingly reflect the use of a CNC or chitin nanoparticle to form an injected CNC or chitin-stabilized emulsion for conformance control in an enhanced oil recovery operation.

One general aspect of the innovations disclosed herein includes a process for conformance control in an enhanced oil recovery operation, including: providing prepared cellulose nanocrystals (CNC) that are salted or desulfated, having an average maximum dimension of ≤1 μm. generating a CNC-stabilized oil in water emulsion from the prepared CNC; injecting the CNC-stabilized emulsion into a zone of a porous subsurface formation; resting the injected CNC-stabilized emulsion in situ in the zone of the porous subsurface formation so as to increase the viscosity of the rested injected CNC-stabilized emulsion.

Implementations of the present innovations may include one or more of the following features. The process where sulfated cellulose nanocrystals are desulfated by treatment with a desulfating acid to provide the prepared CNC. The process where the desulfating acid includes hydrochloric acid or sulfuric acid. The process where the cellulose nanocrystals have a rod-shaped morphology The process where the rod-shaped cellulose nanocrystals have an average length of less than about 900, 800, 700, 600, 500, 400, 300, 200, or 100 nm; or about 50-900 nm; or about 50-250 nm, about 75-225 nm or about 100-200 nm The process where the rod-shaped cellulose nanocrystals have an average width of about 5, 10, 15, 20 or 25 nm; or between 2-100 nm, or 10-50 nm. The process where the rod-shaped cellulose nanocrystals are spray dried cellulose nanocrystals. The process where the spray dried cellulose nanocrystals have an average length of about 100-200 nm and average width of about 15 nm. The process where the average apparent hydrodynamic diameter of the cellulose nanocrystals before the cellulose nanocrystals are desulfated is about 60, 70, 80, 90 or 100 nm; or is in the range of about 60-100 nm. The process where the average ζ-potential of the cellulose nanocrystals before the cellulose nanocrystals are desulfated is about −25 mv, −30 mv, −35 mv, −40 mv, −45 mv, −50 mv or −55 mv; or is in the range of about −25 mv to −55 mv. The process where the average apparent hydrodynamic diameter of the desulfated cellulose nanocrystals is about 150, 175, 200, 225, 250, 255, 275, 300 or 325 nm; or in the range of about 150-325 nm. The process where the average ζ-potential of the desulfated cellulose nanocrystals is about −8 mv, −10 mv, −12 mv, −14 mv or −16 mv; or is in the range of about −8 mv to −16 mv. The process where the average apparent hydrodynamic diameter of the cellulose nanocrystals before the cellulose nanocrystals are desulfated is about 80 nm. The process where the average ζ-potential of the cellulose nanocrystals before the cellulose nanocrystals are desulfated is about −40 mv. The process where the average apparent hydrodynamic diameter of the of desulfated cellulose nanocrystals is about 250 nm. The process where the average ζ-potential of the desulfated cellulose nanocrystals is about −12 mv. The process where the oil in water emulsion an: about 30:70 oil in water emulsion; about 40:60 oil in water emulsion; about 50:50 oil in water emulsion; about 60:40 oil in water emulsion; or about 70:30 oil in water emulsion. The process where the oil in water emulsion an about 50:50 oil in water emulsion. The process where the concentration of the cellulose nanocrystals in the emulsion is about 5, 10, 15, 20, 25, 30 or 35 mg_{CNC}/mLₒ CNC. The process where the concentration of the cellulose nanocrystals in the emulsion is from about 5-50 mg_{CNC}/mLₒ CNC; or about 20 mg_{CNC}/mLₒ CNC. The process where the average droplet size of cellulose nanocrystals in the emulsion is about 2, 3, 4, 5, 6, 7, 8, 9 or 10 μm; or is in the range of from about 3-8 or 4-10 μm. The process where the average droplet size of cellulose nanocrystals in the emulsion is about 7 μm. The process where the average droplet size of cellulose nanocrystals in the emulsion is smaller than the average pore throat diameter of at least a zone in the formation. The process where the average pore throat diameter of the zone is at least 40, 45 or 50 μm; or is from 40-100 μm; or is about 54 μm/. The process where the average droplet size to pore throat ratio is about 0.10, 0.11, 0.12, 0.13, 0.14, 0.15 or 0.16; or is from 0.10 to 0.16; or is about 0.13. The process where the formation includes a hydrocarbon reservoir. The process where the enhanced oil recovery operation is a water flooding operation. The process where the rested CNC-stabilized emulsion in situ in the zone forms a barrier to the flow of water in the zone. The process where the rested CNC-stabilized emulsion in situ in the zone forms a barrier to the flow of oil in the zone. The process where the rested CNC-stabilized emulsion in situ in the zone forms a fluid flow barrier in the zone. The process where the fluid flow barrier forms a barrier to flow of water in the zone that is greater than the barrier formed to the flow of oil in the zone. The process where the strength of the fluid flow barrier is proportional to the strength of an interdroplet network. The process where the strength of the fluid flow barrier is dependent on the dielectric strength of fluid in contact with the fluid flow barrier. The process where the rested CNC-stabilized emulsion in situ in the zone has an apparent viscosity of at least 3000, 4000 or 5000 cp; or about 3000-7000, 4000-6000 cp; or about 5000-5500 cp. The process where the zone is an unconsolidated zone. The process where viscoelasticity of the emulsion increases with time due to van der Waals/hydrogen bonding interactions between the CNCs on droplet surfaces. The process of the claims 1t, where sulfated CNC are treated with salt to provide the prepared CNC. The process where the salt is NaCl. The process where the NaCl is about 50 mm. The process where the additional biopolymer is a chitin nanocrystal, a nanoparticle, a surfactant or a biopolymer. The process of the claims 1, where the stabilized emulsions is further stabilized with an additional polymer.

### BRIEF DESCRIPTION OF THE DRAWINGS

FIG. 1 is a schematic illustration of a typical sandpack setup for conformance control examples.

FIG. 2 is a line graph illustrating apparent hydrodynamic diameter for the exemplified a-CNCs (CNCs prior to surface treatment) and b-CNCs (CNCs after surface treatment), evidencing an increase in particle size after surface treatment and ζ-potential for a-CNCs and b-CNCs where b-CNCs have a lower value of ζ-potential.

FIG. 3 includes two panels, upper panel (a) and lower panel (b), illustrating: (a) Vial images for emulsion prepared with b-CNC at different concentrations and equal volumes of dodecane and aqueous phase after one day. Emulsion prepared with 20 mg_{CNC}/mL_{O} was most stable to creaming (b) a line graph illustrating the evolution of Sauter average droplet diameter of prepared emulsions with time. Emulsion prepared with 20 mg_{CNC}/mL_{O} has the smallest droplet diameter and least coalescence over time.

FIG. 4 includes three micrographs, illustrating: (a) a LSCM image of 20 mg_{CNC}/mL_{O}. Oil droplets are surrounded by a layer of CNCs of distinct shades. The arrow indicates the presence of CNC networks in between droplets. (b) & (c) Cryo SEM images of the CNC emulsion indicating bridging of droplets due to the CNC networks and thick layer of CNC at the interface.

FIG. 5 includes two panels, each with a line graph, illustrating: (a) An increase in the modulus of b-CNC stabilized emulsions over time, putatively attributed to strengthening of a droplet network due to short-range interactions (i.e. van der Waals/Hydrogen bonding). (b) An increase in emulsion viscosity for a 20 mg_{CNC}/mL_{O} CNC emulsion from 1 hour after preparation to 24 hours after preparation.

FIG. 6 is a graph illustrating the pressure gradient and apparent viscosity during injection of a 20 mg_{CNC}/mL_{W} CNC suspension through a sandpack, demonstrating minimal retention and an increase in pressure gradient in proportion to the viscosity of the suspension.

FIG. 7 includes a graph annotated with images, illustrating flow behavior of CNC stabilized emulsions. As discussed in the Examples, emulsion breakthrough occurred around 1.3 PV after which time the effluent was stable emulsion.

FIG. 8 includes two graphs, illustrating that: Average droplet size increased by 1-2 μm as the emulsion flowed through the porous media; sample numbers increase with pore volume injected; Droplet size became constant after sample #15 or 3 PV corresponding to a steady pressure gradient while injection (FIG. 7). The collected effluent samples #6, #7, #10, and #15 were diluted with water displaced from the sandpack and thus exhibit smaller viscosities.

FIG. 9 is a graph illustrating selective blocking performance of a 20 mg_{CNC}/mL_{O} CNC stabilized emulsion. Constant pressure water injection test after 24 hours shows that a threshold pressure gradient of around 350 psi/ft is needed for water to breakthrough, but a much smaller gradient (72.5 psi/ft) was required for oil to breakthrough.

FIG. 10 includes two graphs, illustrating: (a) Flow behavior of a 40:60 oil:water ratio emulsion. The pressure gradient was 2.3 times lower than for a 50:50 oil:water emulsion. (b) Shear thinning behavior of the emulsions tested for conformance control. The 50:50 oil:water emulsion viscosity was 2 times higher than for a 40:60 oil:water CNC stabilized emulsion. The CAPB and PAM stabilized emulsion has the lowest viscosity (10 times lower than 50:50 CNC emulsion).

FIG. 11 is a line graph illustrating that, in contrast to b-CNC stabilized emulsions, the viscosity of CAPB/PAM stabilized emulsion did not change over time. The difference is due to absence of network formation in the surfactant/polymer stabilized emulsion.

FIG. 12 includes two graphs, illustrating: (a) Injectivity of CAPB/PAM stabilized emulsion through sandpack. (b) Constant pressure water injection after 24 hours shut in showed that water entered at the lowest gradient tested and began to displace the emulsion at a gradient of 8 psi/ft.

FIG. 13 is a graph illustrating the pressure profile during injection of chitin emulsion in porous media (sandpack).

FIG. 14 is a graph illustrating two data series showing constant pressure injection of water (large circles) and oil (smaller circles) in emulsion saturated porous media, evidencing selective blocking by chitin emulsions.

### DETAILED DESCRIPTION

As described in more detail below, CNCs and chitin nanoparticles have been used in the Examples herein as an emulsion stabilizer, with demonstrated effectiveness as a conformance control agent. Aspects of the approach described herein involve creating interdroplet networks in nanopartide stabilized concentrated emulsion (φᵥ=0.5) that impart very large and selective resistance to the flow of water. To illustrate the effectiveness of this strategy, CNC stabilized emulsions are compared to surfactant and polymer stabilized emulsions. We accordingly disclose the application of CNC or chitin stabilized oil in water emulsions as a selective phase blocking system for conformance control in EOR processes.

As exemplified herein, CNC stabilized emulsions have an ability to form strong droplet networks with time. While not being bound by any theory, this may in some embodiments be due to van der Waals and hydrogen bonding interactions (van der Berg et al., 2007) between CNCs adsorbed on droplet surfaces and in the continuous phase. This property was utilized for conformance control examples which illustrate that the stabilized emulsions were able to effectively block the flow of water at a threshold pressure gradient of 350 psi/ft, providing evidence of a strong droplet network. The strength of this network may be adapted to be time dependent, and therefore amenable to manipulation by the shut-in time. The emulsions were stable while flowing through porous media, with a minor increase in droplet size of 1-2 μm, putatively due to limited coalescence in Pickering emulsions (Arditty et al., 2003). We disclose differences in viscosities of the effluent emulsion samples due to a change in the dispersed phase concentration while flowing through a water saturated sandpack.

The present emulsions have also been shown to block the flow of oil, with the threshold pressure gradient required being 5 times lower than that for water. The emulsions can demonstrably be tuned to specific applications by changing the oil water ratio. By decreasing the oil volume fraction, the viscosity and the corresponding pressure gradient required to place the emulsion can be decreased. The selective blocking capability of the emulsions was persistent even after changing the oil:water ratio, indicating that it is a property of the nanomaterial not of the bulk fluid phases.

While not being bound by theory, the selective behavior of the exemplified emulsions may be understood, for purposes of adapting the emulsions to different uses, as being based on the strength of CNC networks. In this model, when colloidal particles are dispersed in non-polar media with a low dielectric constant (E) (dodecane in our case, E=2) the van der Waals interactions are weaker as compared to the colloidal dispersion in water with a higher dielectric constant value (E=80) (Smith et al., 2017). Therefore, during constant pressure dodecane injection, as the droplets come in contact with dodecane, the strength of the droplet network is reduced due to reduction in the magnitude of vdW attraction. Therefore, in one model of the disclosed systems, the RPM (Relative permeability modifier) effect of the emulsion is dependent on the strength of the droplet network which is dictated by the dielectric constant of the surrounding fluid.

In contrast to the exemplified embodiments, in a control example carried out with a CAPB/PAM stabilized emulsion, there is putatively no mechanism for forming a droplet network, and consequently the emulsion viscosity did not change with time. The emulsion was not able to block the flow of water (flow started at a gradient of only 1 psi/ft), which may be attributed to the absence of the droplet network.

The present disclosure accordingly exemplifies the applicability of CNC or chitin stabilized oil in water emulsions for conformance control and preferential phase blocking. Rheological examples reveal that the emulsion droplets form stronger networks which increases in magnitude with time. This unique property of CNC or chitin stabilized emulsions also occurs when the emulsions are aged in porous media. The aged emulsions block the flow of water until exposed to very large threshold pressure gradients. These emulsions accordingly offer a solution for excessive water production in EOR operations where zonal isolation is either cumbersome or not possible.

The exemplified emulsions are compared to emulsions stabilized with a surfactant and a commercial polymer with similar droplet sizes. The surfactant and polymer stabilized emulsion was unable to block the flow of water/oil once placed inside the porous media, and significant displacement of the emulsion began at pressure gradients two orders of magnitude smaller than for the CNC-stabilized emulsions. The much larger blocking resistance may be conceptually attributed to the droplet networks, which form because of the tailored treatment of the CNCs. The mechanism of droplet network formation in these nanoparticles may be conceptualized as including a contribution from van der Waals forces—a surface property of the nanoparticles. The presently disclosed approach thus offers the opportunity to design selective phase blocking protocols, as demonstrated by the demonstration that oil could enter an emulsion-saturated porous medium at a significantly smaller pressure gradient than water.

In the context of the present disclosure, various terms are used in accordance with what is understood to be the ordinary meaning of those terms. For example, “petroleum” or “oil” is a natural or synthetic mixture consisting predominantly of hydrocarbons in the gaseous, liquid and/or solid phase. In the context of the present application, the words “oil”, “petroleum” and “hydrocarbon” are accordingly used to refer to mixtures of widely varying composition. “Fluids”, such as petroleum fluids, include both liquids and gases.

A geological or subsurface “formation” is a unit of stratigraphy, generally consisting of strata that have comparable lithology, facies or other common properties. A reservoir is a subsurface formation containing one or more natural accumulations of moveable petroleum, which are generally confined by relatively impermeable rock. An “oil sand” or “tar sand” reservoir is generally comprised of strata of sand or sandstone containing petroleum. A “zone” in a reservoir is an arbitrarily defined volume of the reservoir, typically characterised by some distinctive property. Zones may exist in a reservoir within or across strata, and may extend into adjoining strata.

As used herein, the term “oil in water emulsion” means an at least temporarily stable mixture of immiscible fluids, comprising finely divided oil droplets (a predominantly hydrocarbon phase) suspended in a continuous aqueous phase. Similarly, a “water in oil emulsion” comprises finely divided aqueous droplets suspended in a continuous oil (predominantly hydrocarbon) phase.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Terms such as “exemplary” or “exemplified” are used herein to mean “serving as an example, instance, or illustration.” Any implementation described herein as “exemplary” or “exemplified” is accordingly not to be construed as necessarily preferred or advantageous over other implementations, all such implementations being independent embodiments. Unless otherwise stated, numeric ranges are inclusive of the numbers defining the range, and numbers are necessarily approximations to the given decimal. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification, and all documents cited in such documents and publications, are hereby incorporated herein by reference as if each individual publication were specifically and individually indicated to be incorporated by reference herein and as though fully set forth herein. The invention includes all embodiments and variations substantially as hereinbefore described and with reference to the examples and drawings.

### EXAMPLES

As disclosed in the following Examples, confocal microscopy coupled with Cryo-SEM provides a precise characterization of emulsion microstructure, and facilitates a correlation to the rheological behavior of the emulsions. Rheological measurements reveal that a strong droplet network forms within the emulsions over time. Importantly, the same network forms when the emulsions occupy pore space in a granular material. Emulsions were injected through a sandpack with a porosity of 35% and average pore diameter of 54 μm. The injected emulsions were aged inside the porous media for 24 hours. Thorough assessment of the collected effluent samples revealed that the emulsion was stable. The porous medium was then subjected to a gradually increasing pressure gradient of either water or oil. Gradients greatly exceeding typical near-well values (>300 psi/ft) were required to establish flow, and the resulting flow rate exhibited a pressure gradient three orders of magnitude higher than in an untreated water saturated sandpack. Interestingly, a significantly larger gradient was needed for water to flow than for oil, evidencing the prospect of using this class of emulsions for selective phase blocking, and as relative permeability modifiers. Moreover, emulsions stabilized with other material allowed water to flow at very small gradients, confirming that network formation is a feature of this aspect of the present innovations.

### Surface Treatment of CNCs and Characterization

Spray dried CNCs with an average length of 100-200 nm and width of 15 nm were supplied by Alberta Innovates Technology Futures (AITF). 10 mg/mL CNC suspension was mixed with an appropriate amount of 12 M HCl to give a concentration of 2.5 M HCl and subsequently stirred at 100° C. for 5 hours (Kalashnikova et al., 2012). The reactions were stopped by dilution with purified water. The diluted CNC suspensions were then centrifuged (Eppendorf Centrifuge 5810, 4000 RPM for 30 minutes), and the supernatant discarded. The treated CNCs were re-suspended in water and centrifuged 3 more times, before dialysis (SpectralPor MWCO:12-14 kD) against purified water for 3 days to remove any remaining impurities. CNCs were then fluorescently labelled with RITC (7.5 mg RITC/g of CNC) using a one-pot reaction under alkaline conditions (Nielsen et al., 2010). After 3 days, the suspension was washed and centrifuged multiple times, followed by dialysis against purified water for 5 days until a neutral pH was measured. The fluorescently labelled CNCs were freeze-dried (Thermo Scientific ModulyoD-115) and stored at room temperature. The as received AITF CNCs and surface treated CNCs are termed herein as a-CNCs and b-CNCs respectively.

The apparent hydrodynamic diameter of the CNCs was measured using a combination of electrophoresis and laser Doppler velocimetry technique using Malvern® Zetasizer Nano ZS instrument with a wavelength of 633 nm and the scattering angle of 173°. DLS was performed on the dilute suspensions (˜1 mg/mL) and repeated a minimum of 15 times to obtain the particle size distribution. The term “apparent diameter” is used in recognition of the fact that DLS model's spherical particles while CNCs are rod-shaped nanoparticles.

The ζ-potential was determined using a combination in a Malvern® Zetasizer Nano ZS instrument with a disposable cuvette. CNC dispersions of ˜0.25 mg/mL in 10 mM NaCl were prepared and measured a minimum of 3 times. For measuring the ζ-potential of the emulsions, the emulsions were diluted 10-fold with the bottom aqueous phase of the creamed emulsion to prevent changes of ionic composition before each measurement.

### Emulsion Preparation and Characterization.

Freeze dried CNCs were dispersed in DI water using vortex mixing for 30 seconds at 2400 RPM (Fisher scientific digital vortex mixer) followed by 10 minutes of sonication in an ultrasonic bath (Branson 2800 series). The suspension was then ultra-sonicated (Qsonica Q700) in an ice bath at 75% of maximum amplitude (5000 J/10 mL of suspension) to further break up any aggregates. Dodecane was then added to form a 50:50 oil:water ratio by volume and the mixture was homogenized using a rotor stator homogenizer (Pro Scientific PRO 250) with a 10-mm generator at 35000 RPM for 2 minutes. For conformance experiments 200 mL of emulsion was prepared using a 20 mm generator at 35000 RPM for 2 minutes.

For surfactant and polymer stabilized emulsions, a zwitterionic surfactant (CAPB) 0.6 wt % and 0.5 wt % of Polyacrylamide (PAM Molecular Weight-16 million Daltons) provided by SNF, Canada were used and emulsified with a homogenizer as discussed above.

A Leica SP8 inverted LSCM with an 8 kHz resonant scanner was used to acquire 3D image data sets of each emulsion. Dodecane was labelled with perylene dye (0.01 mg/mL) and the CNCs were labelled with RITC, as to enable direct viewing of both the oil droplets and the nanoparticles within the emulsion. Avizo® version 9.3 was used in the quantification and reconstruction of the LSCM 15 data set. The Sauter mean diameter (D_{3,2}) of the droplets was calculated and is defined as the diameter of a droplet that has the same volume/surface area ratio as the sum of all the oil droplets in the emulsion (Eqn. 1).

$${D}_{32} = \frac{{\sum }_{i} {D}_{i}^{3} \times {N}_{i}}{{\sum }_{i} {D}_{i}^{2} \times {N}_{i}} \qquad ( 1 )$$

Where Di is the droplet diameter and Ni is the number of droplets measured.

For cryo-SEM imaging, a Zeiss Ultra Plus high-resolution SEM was used, equipped with a Schottky field-emission gun and with a BalTec VCT100 cold-stage maintained below −145° C.

A stress-controlled rotational rheometer (Anton Paar MCR-302) was employed to perform the rheological analysis. Sandpaper was attached to the parallel plate geometry (25 mm in diameter) of the rheometer to eliminate slippage using double sided tape and the sandpaper was soaked in water prior to experimentation to ensure that the emulsion compositions did not vary upon addition to the measuring system. Samples were carefully loaded onto the rheometer stage using a spatula. A gap size of 1 mm was chosen, and the amplitude sweep demonstrations were performed at a frequency of 0.1 Hz.

The viscosity curve for the emulsions were obtained by a shear rate sweep test with a ramp logarithmic profile.

### Sandpack Flooding Examples.

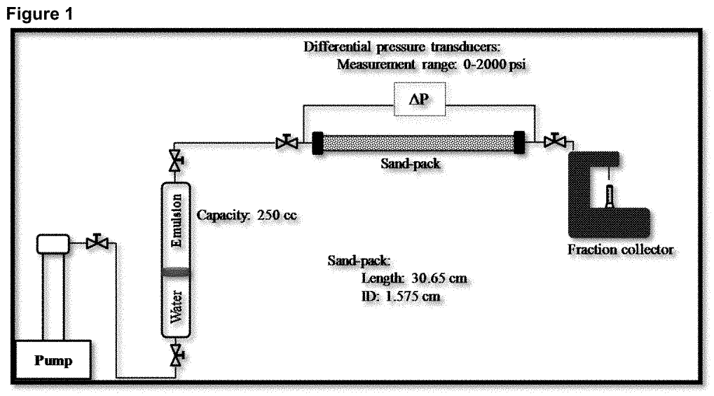

For conformance control examples, a sandpack (30.5 cm and 1.5 cm in length and width, respectively) was prepared using a 50-70 mesh sand. After packing, the sandpack was weighed to get the dry weight. Before saturating the sandpack, with DI water, vacuuming was performed to remove the air in the system. After water saturation, sandpack was weighed again to determine the porosity and pore volume of the sandpack. The permeability of the sandpack was determined by measuring the pressure drop across the water as a function of flow rate. The properties of the sandpack are given below in Table 1. FIG. 1 shows the typical sandpack setup for conformance control examples.

TABLE 1
Porous media (Sandpack) properties

| | | | | Average | Super- | | |
|---|---|---|---|---|---|---|---|
| | | | | pore | ficial | | Shear |
| L | ID | K | Ø | radius | velocity | Residence | rate |
| (cm) | (cm) | (D) | (%) | (μm) | (cm/s) | time (s) | (s⁻¹) |
| 30.65 | 1.57 | 33 (±2) | 35 (±1) | 27 (±2) | 0.0086 | 1320 | 20 (±2) |

Pre-generated emulsions were injected into the sandpack initially saturated with water with a positive displacement pump at a volumetric flowrate of 1 mL/min until a steady state pressure condition was achieved. The flow velocity in the sandpack was 24 ft/d. The differential pressure across the sandpack was measured and recorded. The effluent samples were collected for determining the droplet size distribution and rheological properties.

The emulsion was then allowed to age inside the porous media for one day and was followed by constant pressure injection of either water or dodecane to observe the ability of the emulsions to selectively block the fluids. The initial emulsion sample (before putting in the cylinder), emulsion sample before entering the sand pack (after cylinder) and the effluent samples were collected for drop size analysis and measurement of rheological properties of the emulsions and its effect on the blockage mechanism.

Apparent viscosity of emulsion was estimated by Darcy equation as follows:

$$μ app = K \cdot A \cdot \frac{Δ P}{K} q$$

Where K is permeability (Darcy), A is the cross-section area of the porous media (cm²), ΔP is pressure drop across the porous media (atm), L is the length of porous media (cm) and the q is the flow rate (cm/s).

### Characterization of CNCs

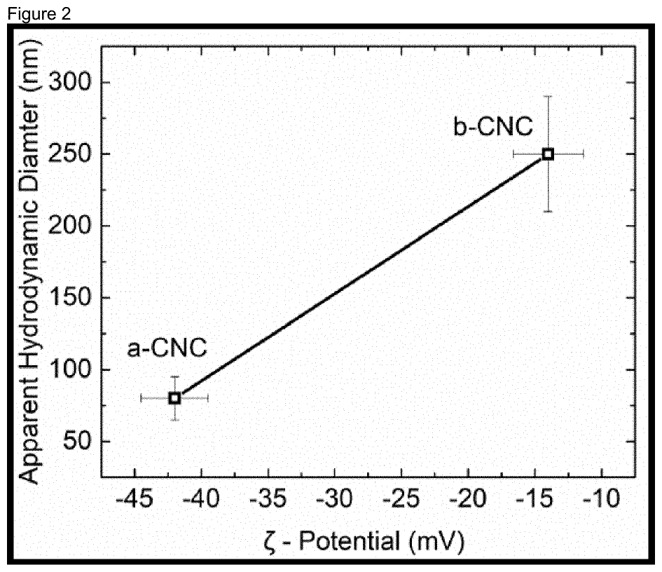

The average apparent hydrodynamic diameter and average ζ-potential for a-CNCs were 80 nm and −40 mV respectively as shown in FIG. 2. After surface treatment with HCl, lateral aggregation and an increase in particle size was demonstrated for b-CNCs. The average apparent hydrodynamic diameter and average ζ-potential for b-CNCs were 250 nm and −12 mV respectively as shown in FIG. 2. The surface treatment of CNCs demonstrably leads to the reduction in surface charge of CNCs, putatively by removing the negatively charged sulfate half ester groups from the surface.

### Characterization of Dodecane-in-Water Emulsions

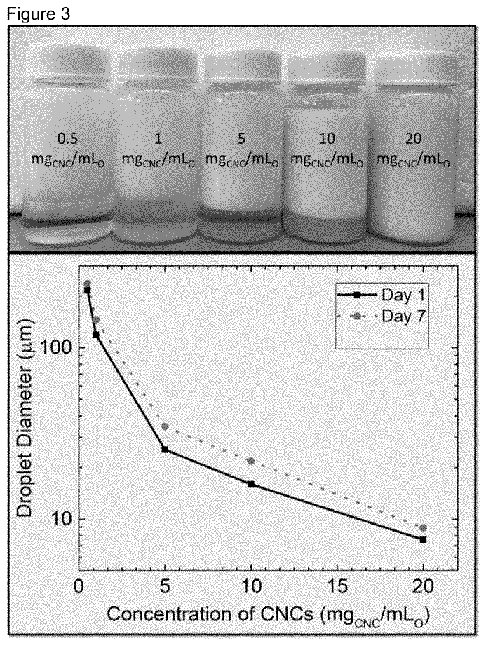

Emulsions were prepared using b-CNC suspensions of 0.5-20 mg_{CNC}/mL_{O}. a-CNCs were not able to stabilize emulsions. FIG. 3 shows that the initial oil volume was completely emulsified by using loadings as little as 0.5 mg_{CNC}/mL_{O} of b-CNCs, however, it was observed that emulsions prepared with 20 mg_{CNC}/mL_{O} of b-CNC were most stable to creaming after one day and had the smallest droplet size (FIG. 3). Emulsions having CNC concentrations of 20 mg_{CNC}/mL_{O} ware therefore selected for conformance control experiments.

Without being limited to theory, the exemplified slowed creaming rate may for conceptual purposes be attributed to the smaller average droplet size, and an attendant increase in the viscosity of continuous phase as the CNC loading was increased along with particle-particle interactions. CNCs may be conceptualized as being prone to form stronger networks in a water phase due to van der Waals and/or hydrogen bonding (van der Berg et al., 2007). Therefore, in conceptual terms, the ability of the non-interfacially adsorbed CNCs in the continuous phase to form a 3-dimensional particle network around oil droplets, along with the formation of strong droplet network due to the interactions between the CNCs around the droplets with the non-adsorbed CNCs in the continuous phase, may be understood to suppress creaming.

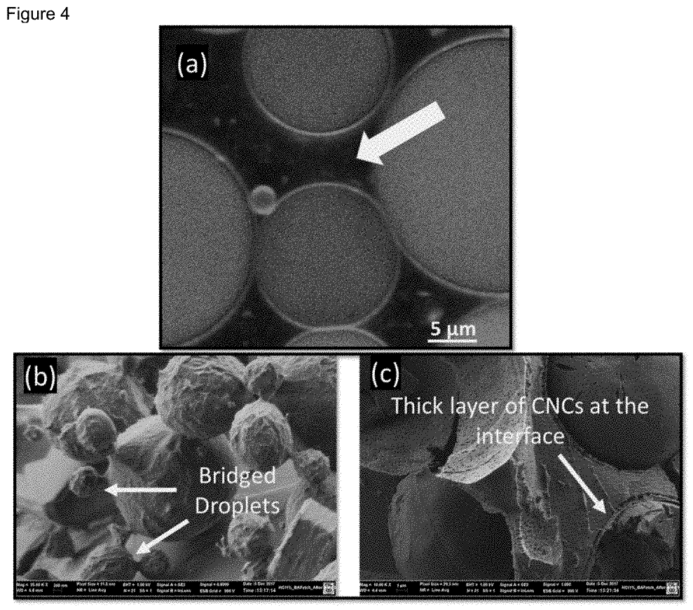

The presence of CNC networks and a thick layer of CNCs at the interface was further confirmed by LSCM and Cryo-SEM imaging (FIG. 4). A thicker layer of CNCs along with CNC networks accordingly is demonstrated to provide long term stability and high viscoelasticity to the exemplified emulsions—as confirmed by the rheological testing.

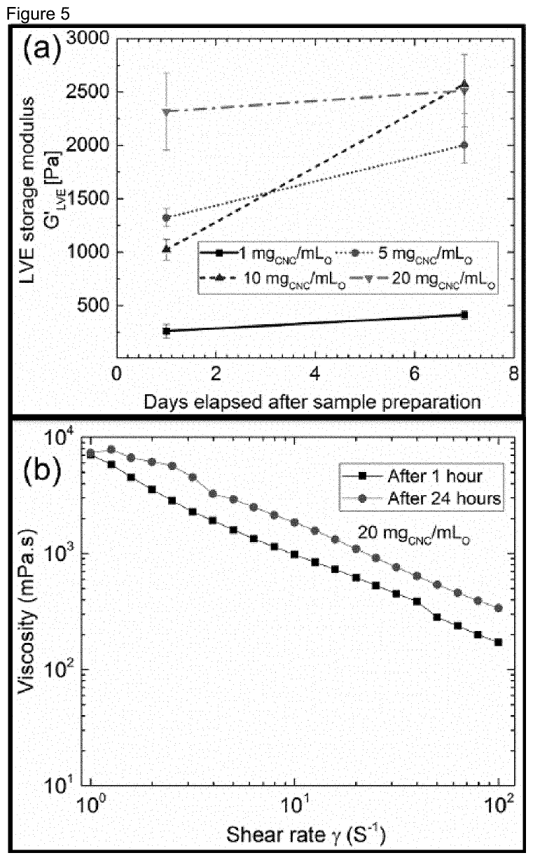

In order to illustrate the behavior of the emulsion under shear, oscillatory strain sweep testing was performed as the emulsions aged for 1 and 7 days. From these tests G′_{LVE} (storage modulus in the linear viscoelastic region) was determined indicating an increase in the gel like behavior of emulsions. In conceptual terms, for purposes of adapting alternative embodiments, this may be attributed to a characteristic that, as the emulsions aged, and the droplets are more closely packed, CNCs around the droplets form stronger droplet networks due to van der Waals interactions and hydrogen bonding (Lewis et al., 2016; van der Berg et al., 2007) (FIG. 5 (a)). Moreover, as the emulsion creams and the droplet volume fraction increases above the glass transition volume fraction (q=0.58), the increase in the elastic modulus is also due to trapping of droplets in transient cages formed by their nearest neighbors (Quemada and Berli, 2002). However, for emulsion prepared with 20 mg_{CNC}/mL_{O} the volume fraction of emulsion is 0.5, therefore an increase in solid like behavior due to caging of droplets is not present in these embodiments.

With respect to the change in viscosity for 20 mg_{CNC}/mL_{O} CNC emulsions, for conformance control experiments, viscosity profiling was performed for the emulsion 1 hour after preparation and 24 hours after preparation (FIG. 5 b). An increase in emulsion viscosity was demonstrated as the emulsion aged—putatively due to network strengthening.

### Flow of CNC Suspension Through Porous Media

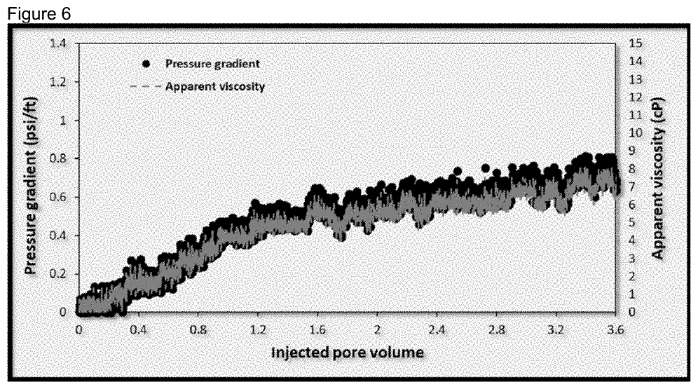

In this aspect of this Example, the effect of CNC suspension on permeability reduction and conformance control was tested. 20 mg_{CNC}/mL_{w} of CNC suspension was injected into the sandpack until a stable pressure gradient was observed (around 3 PV). Afterwards, water was injected at a constant pressure to observe any blockage due to the CNCs. As shown in FIG. 6, the maximum pressure gradient across the sandpack encountered was around 0.8 psi/ft which was higher than the gradient for water flow at the same velocity, which was around 0.2 psi/ft. The increase in gradient is due to the higher viscosity of the nanopartide suspension (6.4 cP at a shear rate of 20 s⁻¹). ICP-MS was performed to measure the nanopartidcle retention in porous media which was around 12% after 3.6 PV of nanopartide injection.

CNC suspension was allowed to age in the porous media for 24 hours and followed by constant gradient water injection. The water flowed easily through the sandpack even at very small gradients. This illustrates that the CNC suspension alone does not create sufficient network structure to block the flow of water and or act as a conformance control agent.

### Flow of CNC Stabilized Emulsion Through Porous Media

As demonstrated in the rheological aspects of this Example (FIG. 5), bulk phase CNC stabilized emulsions form strong droplet networks with time. To illustrate how these networks also form when the emulsion resides in the pore space, a pre-generated 50:50 oil in water emulsion with 20 mg_{CNC}/mL_{O} CNC was injected into the sandpack until a stable pressure drop was observed, then shut in for 24 h.

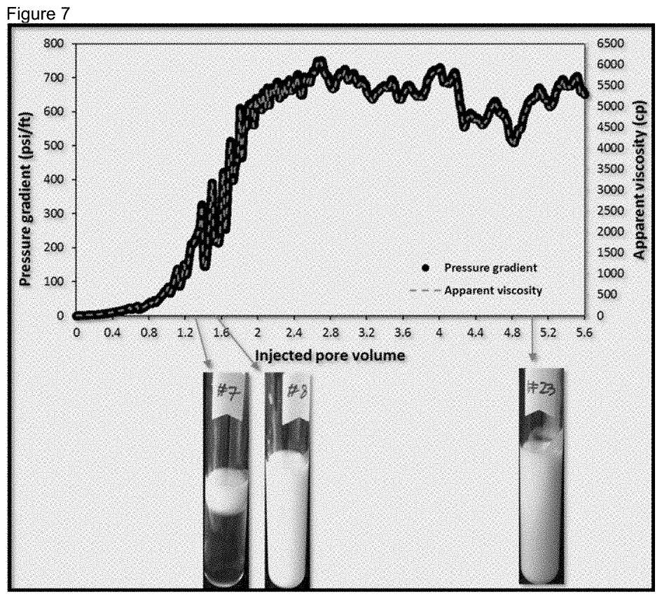

FIG. 7 depicts the pressure response of the emulsion flow through porous media. After 3 pore volume (PV) of emulsion injection the pressure was fairly constant with some pressure fluctuations which may be conceptualized as an indication of competition between blockage and release of emulsion droplets in the porous media. The maximum pressure gradient across the sandpack encountered in the exemplified systems was in the range of 700-750 psi/ft, corresponding to an apparent viscosity of 5000-5500 cP. This is much larger than the bulk emulsion viscosity at a similar shear rate from the rheological experiments.

The average droplet size in the exemplified embodiment is 7 μm, which is smaller than the pore throat diameter of 54 μm (average drop size to pore throat ratio of 0.13). Therefore, straining of droplets in pore throats smaller than the droplet diameter (Soo et al., 1986) is not thought to be causing the large pressure gradient in FIG. 7. However, permeability reduction due to retention of droplets by interaction with pore walls (interception), (Demikhova et al., 2016) could have occurred during emulsion flow. In the exemplified systems, for conceptual purposes, the dominant mechanism for blockage may be thought of as the strong network forming ability of CNCs around the droplets as observed from the rheological experiments (FIG. 5) as the emulsions age.

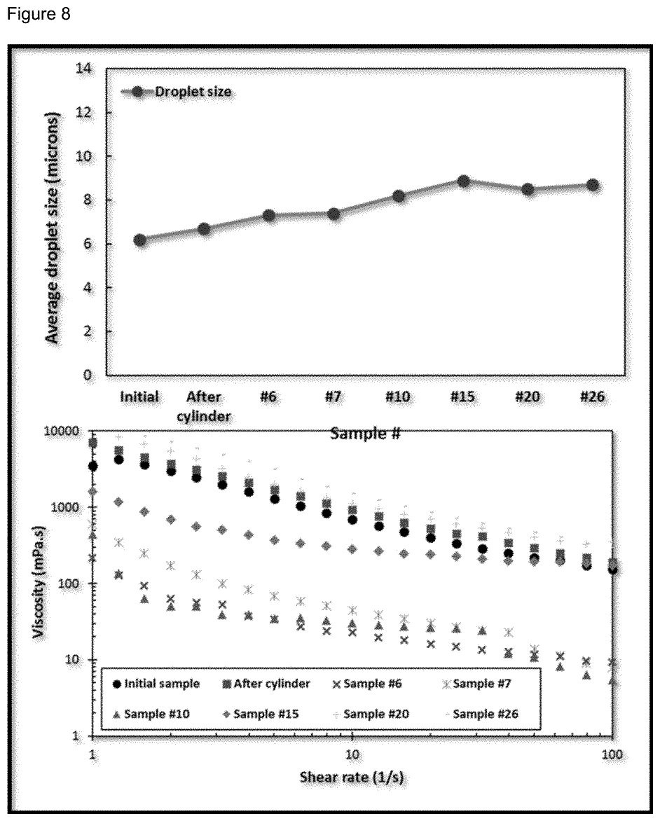

FIG. 8 shows the average droplet size and viscosity-shear rate relationship of the injected emulsion and several effluent samples. The initial sample was collected immediately after emulsification with a homogenizer. The “after cylinder” sample corresponds to the emulsion sample collected from the outlet of the transfer cylinder before entering the sandpack. Average emulsion droplet size in the effluent was slightly larger than the injected emulsion, and the difference grew larger as more emulsion was injected. For conceptual purposes, this can be attributed to the limited coalescence phenomenon observed in Pickering emulsion where droplets coalesce until they reach similar surface coverages (Arditty et al., 2003). After 3 PV of emulsion injection (after sanple #15) the pressure gradient reached a steady state (FIG. 7) and the droplet size became constant (FIG. 8). As emulsion flows through the porous media which was initially saturated with water, it may be diluted resulting in a decrease in the viscosity of the effluent samples (#6, #7 and #10). A similar observation can be made from the apparent viscosity curve in FIG. 7 which reached a steady state after 3 PV (pore volumes) of emulsion injection (sample #15). It was observed that the initial effluent samples had lower viscosity than the initial samples, putatively due to the dilution effect which diminished after 4 PV of emulsion injection (sample #20). This shows that a consistent emulsion (similar droplet size and viscosity) was placed inside the porous media. The higher viscosities of sample #20 and #26 can be attributed to strong network forming ability of the emulsions with time and higher concentration of the dispersed phase as compared to the initial emulsion sample. The after-cylinder sample has slightly higher viscosity than the initial sample as it was measured after the initial sample, in conceptual terms allowing stronger droplet network to form.

### Water/Oil Blocking by CNC Stabilized Emulsions in Porous Media

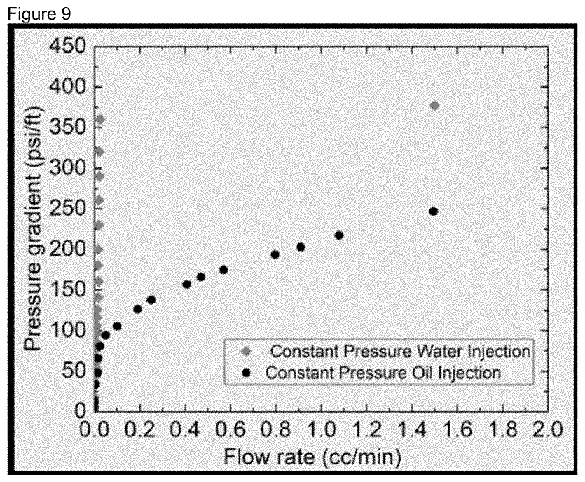

In order to illustrate the blocking efficiency of the exemplified emulsions, constant pressure water/oil injection tests were performed on the porous media saturated with emulsions after 24 hours (FIG. 9). As previously disclosed, these emulsions display strengthening of the droplet network with time. This property of the emulsions is accordingly utilized for examples of conformance control.

As can be seen in FIG. 9, the threshold pressure gradient required for water to form a channel and break through the porous media was around 350 psi/ft.

To illustrate the applicability of these emulsions for selective fluid blocking, emulsion saturated sandpack was followed by constant pressure oil injection instead of water. The threshold pressure required for oil to breakthrough was significantly lower than water 72.5 psi/ft (FIG. 9).

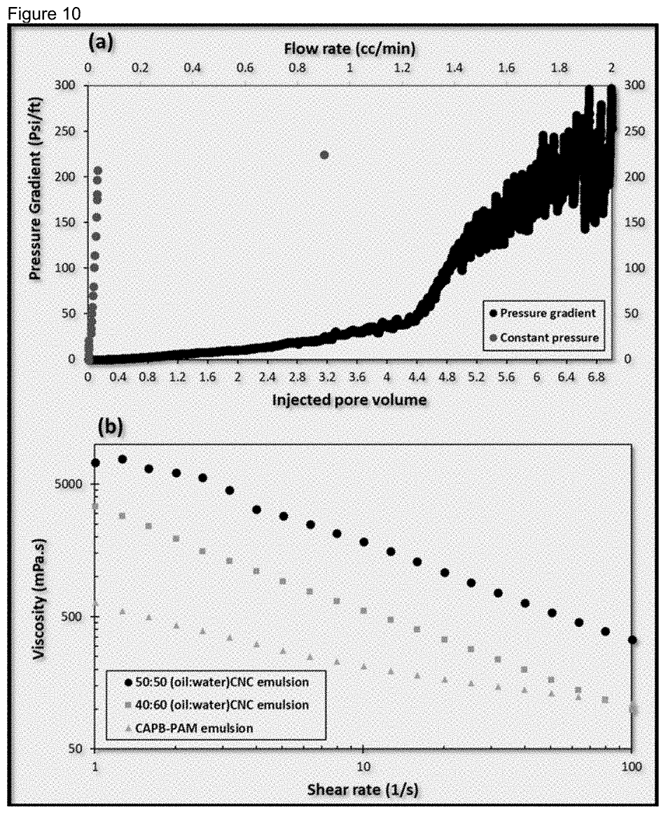

The injectivity of these emulsions can demonstrably be tuned by changing the oil/water ratio of the emulsions (FIG. 10 a,b). Increasing the water content reduces the emulsion viscosity and the pressure gradient during flow. As shown in FIG. 10, the viscosity of a 40:60 oil:water ratio CNC emulsion was half of the 50:50 oil:water ratio emulsion. This has a direct influence on the injection pressure gradient which was 2.3 times lower than a 50:50 oil:water emulsion. The water blocking efficiency was observed to be proportional to the emulsion injection pressure and was 2 times lower than for a 50:50 oil:water ratio emulsion. This illustrates that the emulsions can be tuned as per the application/permissible pressure gradient in the reservoirs of interest and is independent of the droplet size of the emulsions.

### Surfactant/Polymer Stabilized Emulsion for Conformance Control

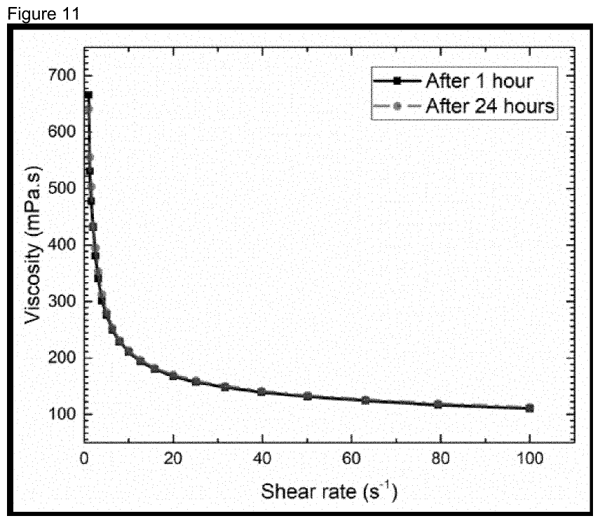

In order to illustrate the effectiveness of CNC stabilized emulsions, injections were carried out with a 50:50 (oil:water) ratio emulsion stabilized with a zwitterionic surfactant (CAPB-0.6 wt %) and Polyacrylamide polymer (PAM-0.5 wt %) through a sandpack. The surfactant stabilized emulsion was not stable to creaming, therefore PAM was added to increase the viscosity of the water phase for suppressing creaming. The average droplet size was 3.5 μm and the viscosity was lower than the CNC stabilized emulsion (FIG. 10 b). The emulsion was stable through the sandpack as all the effluent samples had similar droplet sizes. As shown in FIG. 11, the emulsion did not show any tendency to form networks because the viscosity of the emulsion did not change after 24 hours.

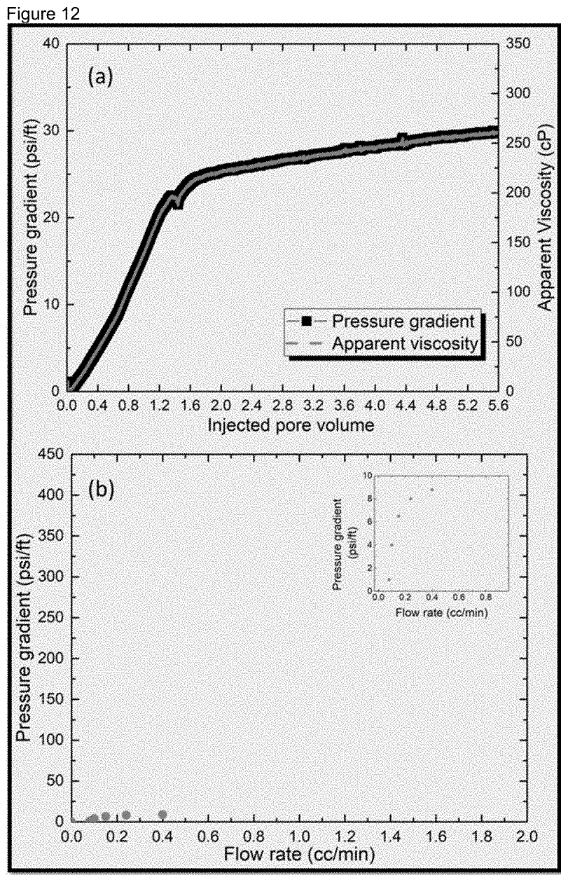

FIG. 12(a) illustrates the injectivity of the emulsion during placement in the sandpack and the fluid blocking capability (FIG. 12(b) after 24 hours shut-in. The injectivity of the emulsion is larger than for the CNC-stabilized emulsions, as expected from its smaller viscosity (cf FIG. 10), but the emulsion did not block the flow of water even at the smallest gradient applied. It is therefore demonstrably unsuitable for conformance control applications.

### Chin Emulsion

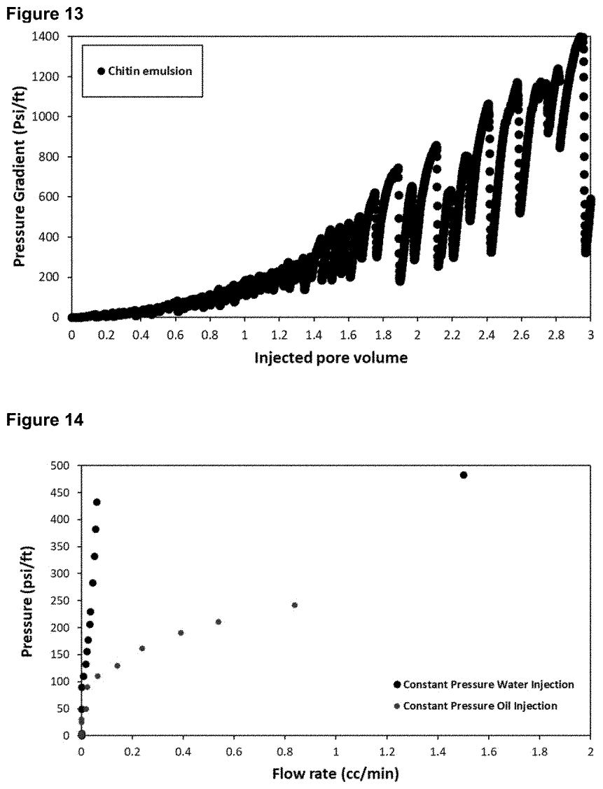

The flow of emulsion (1:1 ratio of oil:water) stabilized with chitin nanoparticles was performed at the same conditions as described for the CNC stabilized emulsion. Pre-generated emulsions were injected into the sandpack initially saturated with water with a positive displacement pump at a volumetric flow rate of 1 mL/min. The differential pressure across the sandpack was measured and recorded, as shown in FIG. 13. The chitin emulsion was then allowed to age inside the porous media for one day and was followed by constant pressure injection of either water or dodecane to illustrate the ability of the emulsions to selectively block the fluids.

Chitin nanoparticles are able to create network structure and result in droplet-droplet interaction of emulsion within porous media (similar to CNC). This results in a selective blocking performance of this emulsion since the strength of the network depends on flowing media (water or oil) as showing in FIG. 14.

### REFERENCES

Abou-Kassem, J. H., Ali, S. M. F., 1995. Modeling of Emulsion Flow In Porous Media. J. Can. Pet. Technol. https://doi.org/10.2118/95-06-02
Arab, D., Kantzas, A., Bryant, S. L., 2018. Nanoparticle stabilized oil in water emulsions: A critical review. J. Pet. Sci. Eng. https://doi.org/10.1016/j. petrol.2017.12.091
Arditty, S., Whitby, C. P., Binks, B. P., Schmitt, V., Leal-Calderon, F., 2003. Some general features of limited coalescence in solid-stabilized emulsions. Eur. Phys. J. E 11, 273-281. https://doi.org/10.1140/epje/i2003-10018-6
Binks, B. P., Horozov, T. S., 2006. Colloidal particles at liquid interfaces, Colloidal Particles at Liquid Interfaces. https://doi.org/10.1017/CBO9780511536670
Błaszczyk, M. M., Sȩk, J. P., Przybysz, Ł., 2017. Modeling of flow resistance and concentration changes during the pressure transport of emulsion through porous media. Chem. Eng. Res. Des. https://doi.org/10.1016/j. cherd.2017.08.018
Cecilie Aadland, R., Jordan Dziuba, C., Heggset, B., Syverud, K., Torsaeter, O., Gates, I., Bryant, S., 2017. TRANSPORTATION OF NANOCELLULOSE DISPERSIONS THROUGH POROUS MEDIA.
Cherhal, F., Cousin, F., Capron, I., 2016. Structural Description of the Interface of Pickering Emulsions Stabilized by Cellulose Nanocrystals. Biomacromolecules 17, 496-502. https://doi.org/10.1021/acs.biomac.5b01413
Demikhova, I. I., Likhanova, N. V., Hemandez Perez, J. R., Falcon, D. A. L., Olivares-Xometi, O., Moctezuma Berthier, A. E., Lijanova, I. V., 2016. Emulsion flooding for enhanced oil recovery: Filtration model and numerical simulation. J. Pet. Sci. Eng. https://doi.org/10.1016/j. petrol.2016.02.018
EIA, 2017. International Energy Outlook 2017 Overview. U.S. Energy Inf. Adm. https://doi.org/www.eia.gov/forecasts/ieolpdf/0484(2016).pdf
Farias, M. L. R. De, Souza, a L. De, Carvalho, M. S., Hirasaki, G., Miller, C., 2012. A Comparative Study of Emulsion Flooding and other IOR Methods for Heavy Oil. SPE Lat. Am. Caribb. Pet. Eng. Conf. https://doi.org/10.2118/152290-MS
Guillen, V. R., Carvalho, M. S., Alvarado, V., 2012. Pore Scale and Macroscopic Displacement Mechanisms in Emulsion Flooding. Transp. Porous Media. https://doi.org/10.1007/sl 1242-012-9997-9
Habibi, Y., Lucia, L. A., Rojas, O. J., 2010. Cellulose nanocrystals: Chemistry, self-assembly, and applications. Chem. Rev. 110, 3479-3500. https://doi.org/10.1021/cr900339w
Horozov, T. S., Binks, B. P., Gottschalk-Gaudig, T., 2007. Effect of electrolyte in silicone oil-in-water emulsions stabilised by fumed silica particles. Phys. Chem. Chem. Phys. 9, 6398-404. https://doi.org/10.1039ib709807n
Kalashnikova, I., Bizot, H., Cathala, B., Capron, I., 2012. Modulation of cellulose nanocrystals amphiphilic properties to stabilize oil/water interface. Biomacromolecules 13, 267-275. https://doi.org/10.1021/bm201599j
Kalashnikova, I., Bizot, H., Cathala, B., Capron, I., 2011. New Pickering emulsions stabilized by bacterial cellulose nanocrystals. Langmuir 27, 7471-9. https://doi.org/10.1021/Ia200971f
Kim, I., Worthen, A. J., Lotfollahi, M., Johnston, K. P., DiCarlo, D. A., Huh, C., 2016. Nanoparticle-Stabilized Emulsions for Improved Mobility Control for Adverse-mobility Waterflooding, in: SPE Improved Oil Recovery Conference. https://doi.org/10.2118/179644-MS
Lewis, L., Derakhshandeh, M., Hatzikiriakos, S. G., Hamad, W. Y., MacLachlan, M. J., 2016. Hydrothermal Gelation of Aqueous Cellulose Nanocrystal Suspensions. Biomacromolecules 17, 2747-2754. https://doi.org/10.1021/acs.biomac.6b00906
Mandal, A., Bera, A., 2015. Modeling of flow of oil-in-water emulsions through porous media. Pet. Sci. https://doi.org/10.1007/s12182-015-0025-x
McAuliffe, C., 1973. Oil-in-Water Emulsions and Their Flow Properties in Porous Media. J. Pet. Technol. https://doi.org/10.2118/4369-PA
McAuliffe, C. D., 1973. Crude-Oil-Water Emulsions to Improve Fluid Flow in an Oil Reservoir. J. Pet. Technol. https://doi.org/10.2118/4370-PA
Moradi, M., Kazempour, M., French, J. T., Alvarado, V., 2014. Dynamic flow response of crude oil-in-water emulsion during flow through porous media. Fuel. https://doi.org/10.1016/j.fuel.2014.06.025
Nielsen, L. J., Eyley, S., Thielemans, W., Aylott, J. W., 2010. Dual fluorescent labelling of cellulose nanocrystals for pH sensing. Chem. Commun. (Camb). 46, 8929-8931. https://doi.org/10.1039/cOccO3470c
Pickering, S. U., 1907. CXCVI.-Emulsions. J. Chem. Soc., Trans. https://doi.org/10.1039/CT9079102001
Quemada, D., Berli, C., 2002. Energy of interaction in colloids and its implications in rheological modeling. Adv. Colloid Interface Sci. https://doi.org/10.1016/S0001-8686(01)00093-8
Smith, G. N., Finlayson, S. D., Rogers, S. E., Bartlett, P., Eastoe, J., 2017. Electrolyte-induced instability of colloidal dispersions in nonpolar solvents. J. Phys. Chem. Lett. 8, 4668-4672. https://doi.org/10.1021/acs.jpclett.7b01685
Soo, H., Williams, M. C., Radke, C. J., 1986. A filtration model for the flow of dilute, stable emulsions in porous media-II. Parameter evaluation and estimation. Chem. Eng. Sci. https://doi.org/10.1016/0009-2509(86)87008-7
Soot, H., Radke, C. J., 1984. The Flow Mechanism of Dilute, Stable Emulsions in Porous Media. Ind. Eng. Chem. Fundam. https://doi.org/10.1021/i00015a014
Thomas, S., Farouq Ali, S. M., 1989. Flow of emulsions in porous media, and potential for enhanced oil recovery. J. Pet. Sci. Eng. https://doi.org/10.1016/0920-4105(89)90038-7
van der Berg, O., Capadona, J. R., Weder, C., 2007. Preparation of homogeneous dispersions of tunicate cellulose whiskers in organic solvents. Biomacromolecules 8, 1353-1357. https://doi.org/10.1021/bm061104q

1. A process for conformance control in an enhanced oil recovery operation, comprising:
providing prepared cellulose nanocrystals (CNC) that are salted or desulfated, or chitin nanoparticles, having an average maximum dimension of ≤1 μm.
generating a CNC or chitin-stabilized oil in water emulsion from the prepared CNC;
injecting the CNC or chitin-stabilized emulsion into a zone of a porous subsurface formation; and,
resting the injected CNC or chitin-stabilized emulsion in situ in the zone of the porous subsurface formation so as to increase the viscosity of the rested injected CNC or chitin-stabilized emulsion.

2. The process of claim 1, wherein sulfated cellulose nanocrystals are desulfated by treatment with a desulfating acid to provide the prepared CNC.

3. The process of claim 2, wherein the desulfating acid comprises hydrochloric acid or sulfuric acid.

4. The process of claim 1, wherein the cellulose nanocrystals have a rod-shaped morphology.

5. The process of claim 4, wherein the rod-shaped cellulose nanocrystals have an average length of less than about 900, 800, 700, 600, 500, 400, 300, 200, or 100 nm; or about 50-900 nm; or about 50-250 nm, about 75-225 nm or about 100-200 nm.

6. The process of claim 5, wherein the rod-shaped cellulose nanocrystals have an average width of about 5, 10, 15, 20 or 25 nm; or between 2-100 nm, or 10-50 nm.

7. The process of claim 6, wherein the rod-shaped cellulose nanocrystals are spray dried cellulose nanocrystals.

8. The process of claim 7, wherein the spray dried cellulose nanocrystals have an average length of about 100-200 nm and average width of about 15 nm.

9. The process of claim 8, wherein the average apparent hydrodynamic diameter of the cellulose nanocrystals before the cellulose nanocrystals are desulfated is about 60, 70, 80, 90 or 100 nm; or is in the range of about 60-100 nm.

10. The process of claim 9, wherein the average ζ-potential of the cellulose nanocrystals before the cellulose nanocrystals are desulfated is about −25 mV, −30 mV, −35 mV, −40 mV, −45 mV, −50 mV or −55 mV; or is in the range of about −25 mV to −55 mV.

11. The process of claim 10, wherein the average apparent hydrodynamic diameter of the desulfated cellulose nanocrystals is about 150, 175, 200, 225, 250, 255, 275, 300 or 325 nm; or in the range of about 150-325 nm.

12. The process of claim 11, wherein the average ζ-potential of the desulfated cellulose nanocrystals is about −8 mV, −10 mV, −12 mV, −14 mV or −16 mV; or is in the range of about −8 mV to −16 mV.

13. (canceled)

14. (canceled)

15. (canceled)

16. (canceled)

17. The process of claim 1, wherein the oil in water emulsion an: about 30:70 oil in water emulsion; about 40:60 oil in water emulsion; about 50:50 oil in water emulsion; about 60:40 oil in water emulsion; or about 70:30 oil in water emulsion.

18. (canceled)

19. (canceled)

20. The process of claim 1, wherein the concentration of the cellulose nanocrystals in the emulsion is from about 5-50 mg_{CNC}/mLₒ CNC; or about 20 mg_{CNC}/mLₒ CNC.

21. process of claim 1, wherein the average droplet size of cellulose nanocrystals or chitin nanoparticles in the emulsion is about 2, 3, 4, 5, 6, 7, 8, 9 or 10 μm; or is in the range of from about 3-8 or 4-10 μm.

22. (canceled)

23. The process of claim 1, wherein the average droplet size of cellulose nanocrystals or chitin nanoparticles in the emulsion is smaller than the average pore throat diameter of at least a zone in the formation.

24. The process of claim 1, wherein the average pore throat diameter of the zone is at least 40, 45 or 50 μm; or is from 40-100 μm; or is about 54 μm/.

25. The process of claim 1, wherein the average droplet size to pore throat ratio is about 0.10, 0.11, 0.12, 0.13, 0.14, 0.15 or 0.16; or is from 0.10 to 0.16; or is about 0.13.

26. (canceled)

27. The process of claim 1, wherein the formation comprises a hydrocarbon reservoir and the enhanced oil recovery operation is a water flooding operation.

28. (canceled)

29. (canceled)

30. The process of claim 27, wherein the rested CNC or chitin-stabilized emulsion in situ in the zone forms a fluid flow barrier in the zone.

31. The process of claim 30, wherein the fluid flow barrier forms a barrier to flow of water in the zone that is greater than the barrier formed to the flow of oil in the zone.

32. The process of claim 31, wherein the strength of the fluid flow barrier is proportional to the strength of an interdroplet network.

33. The process of claim 32, wherein the strength of the fluid flow barrier is dependent on the dielectric strength of fluid in contact with the fluid flow barrier.

34. The process of claim 33, wherein the rested CNC or chitin-stabilized emulsion in situ in the zone has an apparent viscosity of at least 3000, 4000 or 5000 cp; or about 3000-7000, 4000-6000 cp; or about 5000-5500 cP.

35. The process of claim 34, wherein the zone is an unconsolidated zone.

36. The process of claim 1, wherein viscoelasticity of the emulsion increases with time.

37. The process of claim 1, where sulfated CNC are treated with salt to provide the prepared CNC.

38. The process of claim 37, wherein the salt is NaCl.

39. (canceled)

40. The process of claim 1, wherein the stabilized emulsions is further stabilized with an additional polymer that is a nanoparticle, a surfactant or a biopolymer.
